(19) United States
(12) Patent Application Publication
(10) Pub. No.: US 2013/0260353 A1
(43) Pub. Date: Oct. 3, 2013

(54) RESPONSE SUPPORT SERVER, RESPONSE SUPPORT SYSTEM, RESPONSE SUPPORT METHOD

(71) Applicant: FUJITSU LIMITED, Kawasaki-shi (JP)

(72) Inventors: Hidehiko Mayumi, Yokohama (JP); Toshio Tanaka, Yokohama (JP); Takeaki Kobayashi, Yokohama (JP); Takehiro Nabae, Yokohama (JP); Masahiro Kawasaki, Kawasaki (JP)

(73) Assignee: FUJITSU LIMITED, Kawasaki-shi (JP)

(21) Appl. No.: 13/740,563

(22) Filed: Jan. 14, 2013

(30) Foreign Application Priority Data
Mar. 28, 2012 (JP) 2012-074924

(51) Int. Cl. G09B 7/02

(52) U.S. Cl. CPC G09B 7/02
USPC 434/350

(57) ABSTRACT

A response support server is for providing response support to a response terminal for an assignment that has been presented. The response support server includes an input status acquisition unit configured to acquire an input status in a response column for the assignment; a response support information generation unit configured to generate response support information to be displayed on the response terminal, based on the input status and an elapsed time after the assignment is presented; and a send unit configured to send the response support information to the response terminal.

### CROSS-REFERENCE TO RELATED APPLICATION

This patent application is based upon and claims the benefit of priority of the prior Japanese Patent Application No. 2012-074924 filed on Mar. 28, 2012, the entire contents of which are incorporated herein by reference.

### FIELD

The embodiments discussed herein are related to a response support server, a response support system, and a response support method.

### BACKGROUND

In recent years, demonstrational experiments of next generation education using electronic terminals including tablet terminals are being performed. In the future, it is considered that this next generation education will become widespread nationwide.

As one format of a class using next generation education, the teacher gives the students an assignment, the students input their opinions regarding the assignment in tablet terminals, and discussions are made based on the content written in by the students.

In this format, for example, the assignment is sent from the teacher's terminal to the student's terminal, an input column for inputting an opinion for the assignment is displayed, the student inputs his opinion into the student's terminal, and the teacher's terminal receives the result.

Patent Document 1: Japanese Laid-Open Patent Publication No. 2009-511964

Patent Document 2: Japanese Laid-Open Patent Publication No. 2004-199166

Patent Document 3: Japanese Laid-Open Patent Publication No. 2001-356678

However, when a class as described above is held, there may be a student that is unable to input his opinion within a predetermined time period due to thinking too much. Meanwhile, there may be a student who has finished inputting his opinion, and has spare time. In these cases, for a student who is unable to input his opinion, support is preferably given to help the student input his opinion. For a student who has input his opinion, support is preferably given to help the student further expand his thoughts in his spare time.

### SUMMARY

According to an aspect of the embodiments, a response support server for providing response support to a response terminal for an assignment that has been presented, includes an input status acquisition unit configured to acquire an input status in a response column for the assignment; a response support information generation unit configured to generate response support information to be displayed on the response terminal, based on the input status and an elapsed time after the assignment is presented; and a send unit configured to send the response support information to the response terminal.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a system configuration of a response support system;

FIG. 2 illustrates a hardware configuration of a teacher terminal;

FIG. 3 illustrates an example of a student database;

FIG. 4 illustrates an example of an assignment database;

FIG. 5 illustrates an example of a keyword database;

FIG. 6 illustrates an example of a response database stored in the teacher terminal;

FIG. 7 illustrates an example of a functional configuration of the teacher terminal;

FIG. 8 illustrates details of a keyword update unit;

FIG. 9 illustrates an example of a response work table stored in the student terminal;

FIG. 10 illustrates a functional configuration of the student terminal;

FIGS. 11A and 11B are a flowchart for describing operations of the teacher terminal;

FIG. 12 illustrates an example of an assignment selection screen displayed on the teacher terminal;

FIG. 13 is a flowchart for describing a process performed by the keyword update unit;

FIG. 14 illustrates an example of a keyword database after being updated;

FIG. 15 is a flowchart for describing operations of the student terminal;

FIG. 16 illustrates an example of an initial assignment screen;

FIGS. 17A and 17B illustrate a first example where response support information is displayed on the student terminal;

FIGS. 18A and 18B illustrate a second example where response support information is displayed on the student terminal;

FIGS. 19A and 19B illustrate a third example where response support information is displayed on the student terminal; and

FIG. 20 illustrates an example of the response database after the assignment submission time has elapsed.

### DESCRIPTION OF EMBODIMENTS

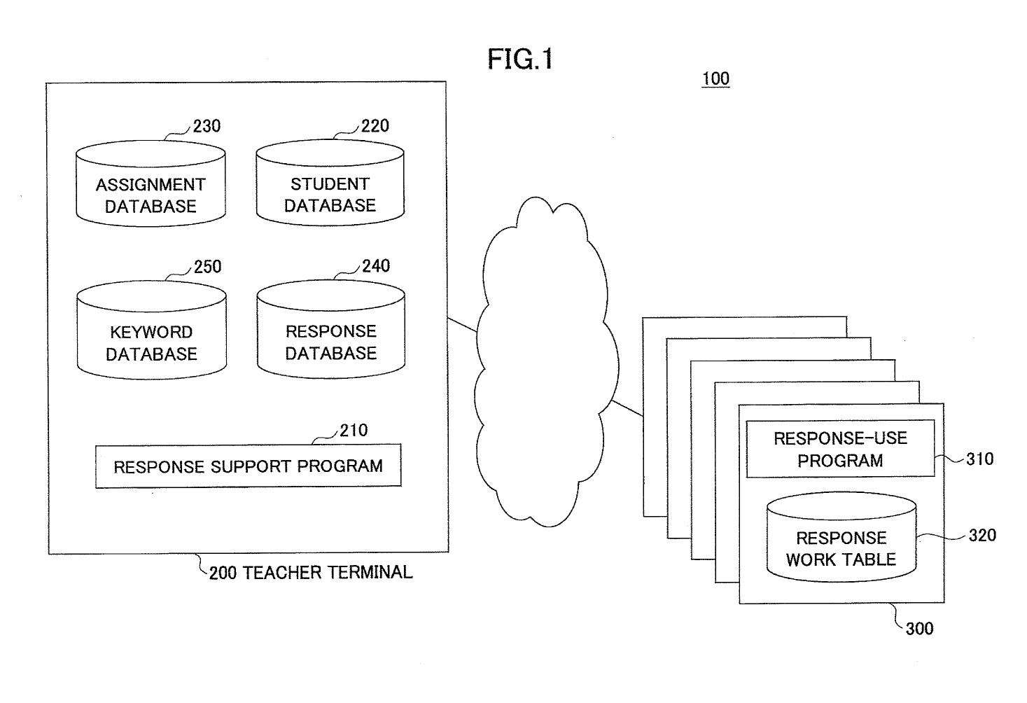

Preferred embodiments of the present invention will be explained with reference to accompanying drawings. FIG. 1 illustrates a system configuration of a response support system.

A response support system 100 according to the present embodiment includes a teacher terminal 200 and student terminals 300 connected via a network such as a wireless LAN (Local Area Network). The teacher terminal 200 according to the present embodiment is a terminal for a teacher used by the teacher in a class of a school, and corresponds to a response support server. The student terminal 300 according to the present embodiment is a terminal for a student that is distributed to all students in the class, and corresponds to a response-use terminal.

In the teacher terminal 200 according to the present embodiment, a response support program 210 is installed. The teacher terminal 200 according to the present embodiment includes a student database 220, an assignment database 230, a response database 240, and a keyword database 250.

In the student terminal 300, a response-use program 310 is installed. Furthermore, the student terminal 300 according to the present embodiment includes a response work table 320.

In the present embodiment, an assignment is sent from the teacher terminal 200 to the student terminal 300, and the assignment and an input column for inputting a response are displayed at the student terminal 300. Furthermore, when a predetermined time period elapses, the teacher terminal 200 according to the present embodiment provides support for inputting a response to the student terminal 300.

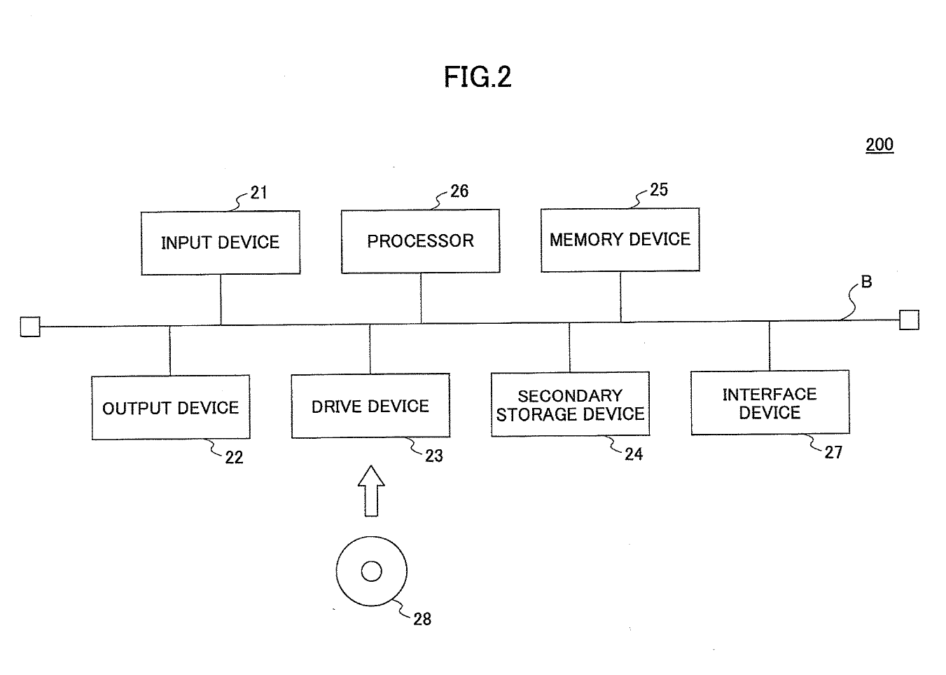

In the following, a description is given of a hardware configuration of the teacher terminal 200 according to the present embodiment. FIG. 2 illustrates a hardware configuration of the teacher terminal 200.

The teacher terminal 200 according to the present embodiment includes an input device 21, an output device 22, a drive device 23, a secondary storage device 24, a memory device 25, a processor 26, and an interface device 27, which are interconnected by a bus B.

The input device 21 includes a keyboard and a mouse, and is used for inputting various signals. The output device 22 includes a display device, and is used for displaying various windows and data. When the teacher terminal 200 according to the present embodiment is a tablet terminal, the input device 21 and the output device 22 are realized by a display operation unit such as a touch panel.

The interface device 27 includes a modem and a LAN card, and is used for connecting to the network.

The response support program 210 according to the present embodiment is one of the various programs for controlling the teacher terminal 200. The response support program 210 is, for example, provided by being distributed in a recording medium 28 or by being downloaded from a network. As the recording medium 28 recording the response support program 210, various types of recording media may be used, such as a recording medium for optically, electrically, or magnetically recording information such as a CD-ROM, a flexible disk, and a magnetooptic disk, or a semiconductor memory for electrically recording information such as a ROM and a flash memory.

When the recording medium 28 recording the response support program 210 is set in the drive device 23, the response support program 210 is installed in the secondary storage device 24 via the drive device 23. The response support program 210 that has been downloaded from a network is installed in the secondary storage device 24 via the interface device 27.

The secondary storage device 24 stores the response support program 210 that has been installed, as well as files and data that are needed. The memory device 25 reads the response support program 210 from the secondary storage device 24 when the computer is activated, and stores the response support program 210. The processor 26 implements various processes as described below according to the response support program 210 stored in the memory device 25.

The student terminal 300 according to the present embodiment is a tablet terminal, and is a computer including a display operation device having an input function and a display (output) function, a processor, and a memory device. Other hardware configurations of the student terminal 300 are the same as those of the teacher terminal 200, and are thus not further described.

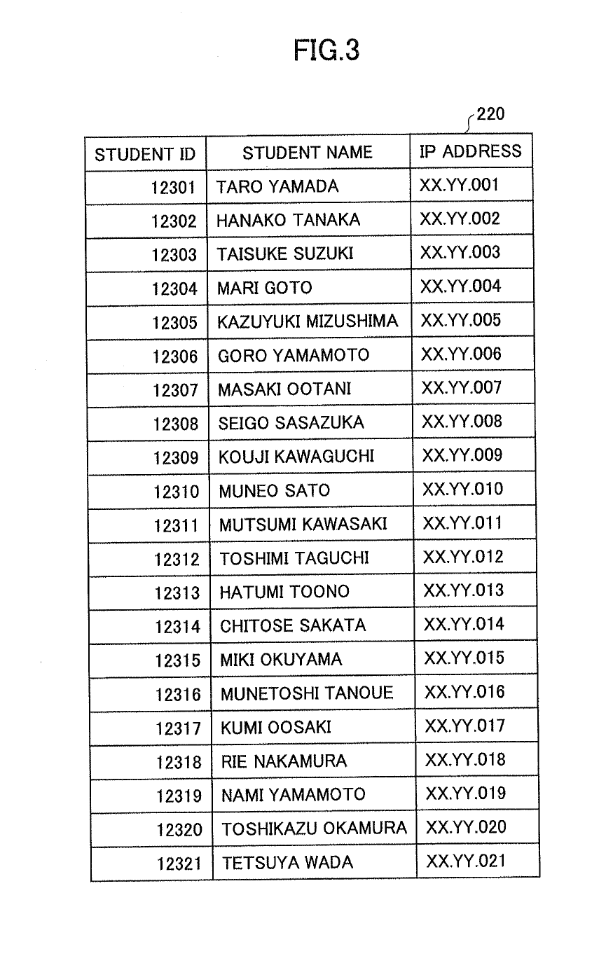

In the following, a description is given of the teacher terminal 200 according to the present embodiment. FIG. 3 illustrates an example of the student database 220.

The student database 220 according to the present embodiment stores, in association with each other, student IDs for identifying students, student's names, and IP addresses for identifying the student terminals 300 distributed to the students. The student database 220 according to the present embodiment is registered in the teacher terminal 200 by the teacher in advance.

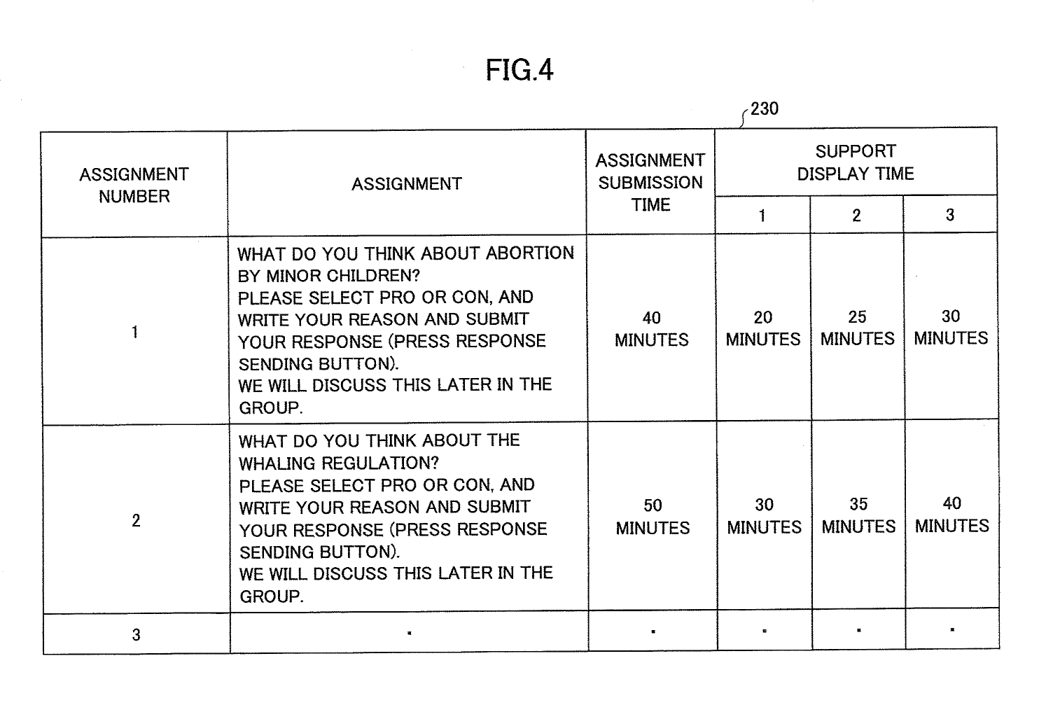

FIG. 4 illustrates an example of the assignment database 230. The assignment database 230 according to the present embodiment stores, in association with each other, assignment numbers for identifying assignments, assignments, assignment submission times, and support display times.

The assignment submission time is the time from when an opinion may be input into the assignment in the student terminal 300 to when the assignment is submitted. The support display time is the time from when an opinion may be input into when response support information for supporting input of an opinion (response) is sent to the student terminal 300.

In the present embodiment, plural values are set for the support display time. For example, for assignment number 1, when 20 minutes pass from when an opinion may be input for an assignment corresponding to the assignment number 1, the first response support information is sent, and when 25 minutes pass, the second response support information is sent.

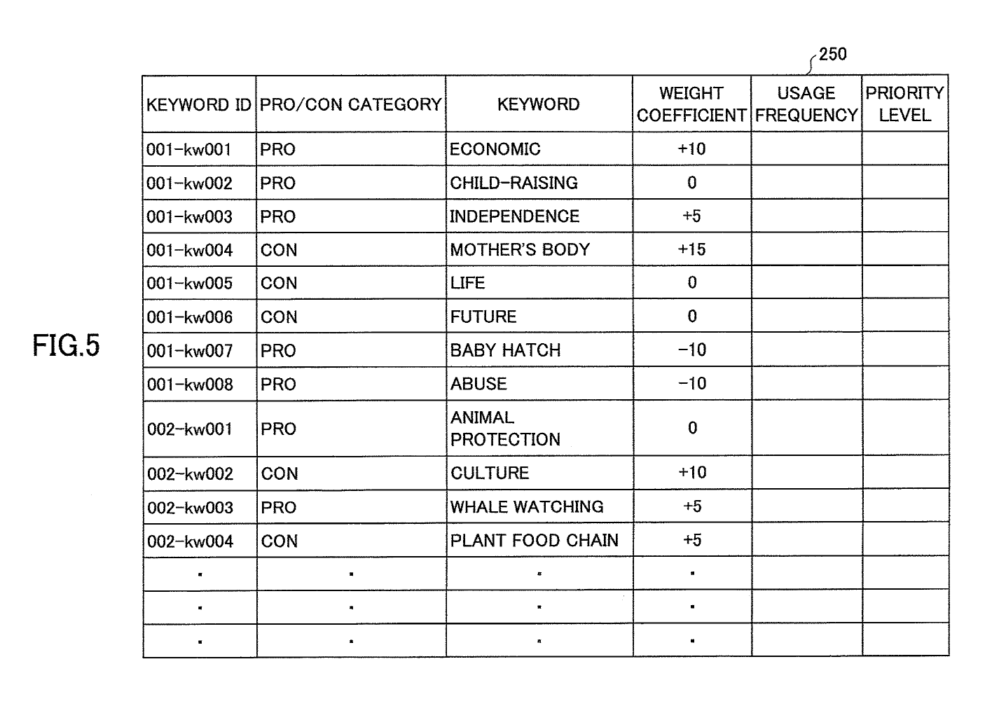

FIG. 5 illustrates an example of the keyword database 250. The keyword database 250 according to the present embodiment stores, in association with each other, keyword IDs for identifying keywords, a pro/con categories, keywords, weight coefficients, usage frequencies, and priority levels. In the present embodiment, a keyword included in the response support information to be sent to the student terminal 300 is selected from the keywords stored in the keyword database 250.

The pro/con category indicates whether the keyword is to be categorized as a pro-side opinion or as a con-side opinion to the assignment. For example, the keyword “economic” corresponding to the keyword ID of 001-kw001 is categorized as a pro-side keyword to the assignment.

The weight coefficient is a value set in advance before input of opinions for an assignment is started. In the present embodiment, the keywords are weighted in advance. For example, a typical keyword may have a high weight coefficient and an inappropriate keyword may have a negative weight coefficient. Accordingly, the priority levels of keywords may be adjusted to some extent.

The usage frequency indicates the number of times the students have used the keyword. The priority level indicates the priority level of the keyword when selected as response support information. In the keyword database 250, values of the usage frequency and priority level are stored every time the keyword database 250 is updated as described below.

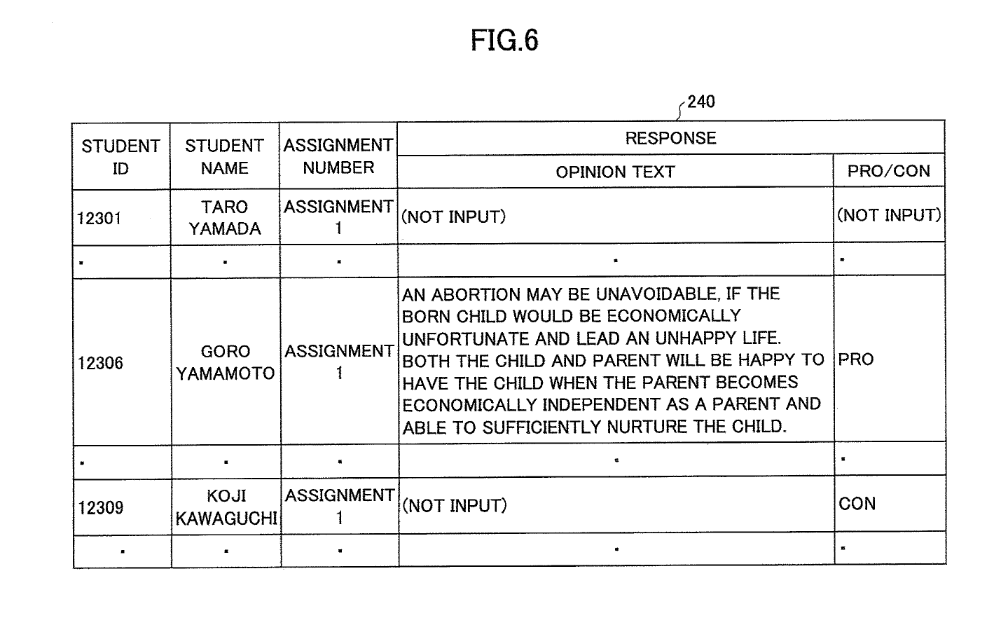

FIG. 6 illustrates an example of the response database 240 stored in the teacher terminal 200. The response database 240 according to the present embodiment stores input results for each student that has input a response in the student terminal 300. That is to say, the response database 240 of the teacher terminal 200 stores, for each of the student IDs, responses acquired from the student terminals 300 distributed to all students in the class. A response includes the opinion text input as text data and pro/con with respect to the question included in the assignment.

The response database 240 according to the present embodiment stores, in association with each other, student IDs, student names, assignment numbers, and responses. The response includes an opinion text and an indication of pro or con. The opinion text is text data input into the opinion input column described below. Pro or con is selected from the options of pro or con in the student terminal 300.

For example, in the example of FIG. 6, the student of student ID 12301 has not input an opinion to assignment 1, and has not selected pro or con. The response database 240 according to the present embodiment is updated every time the response is changed by the student terminal 300. Details of updating the response database 240 are described below.

The above-described databases included in the teacher terminal 200 according to the present embodiment may be provided in a predetermined storage area in the secondary storage device 24 in the teacher terminal 200.

In the following, a description is given of a functional configuration of the teacher terminal 200.

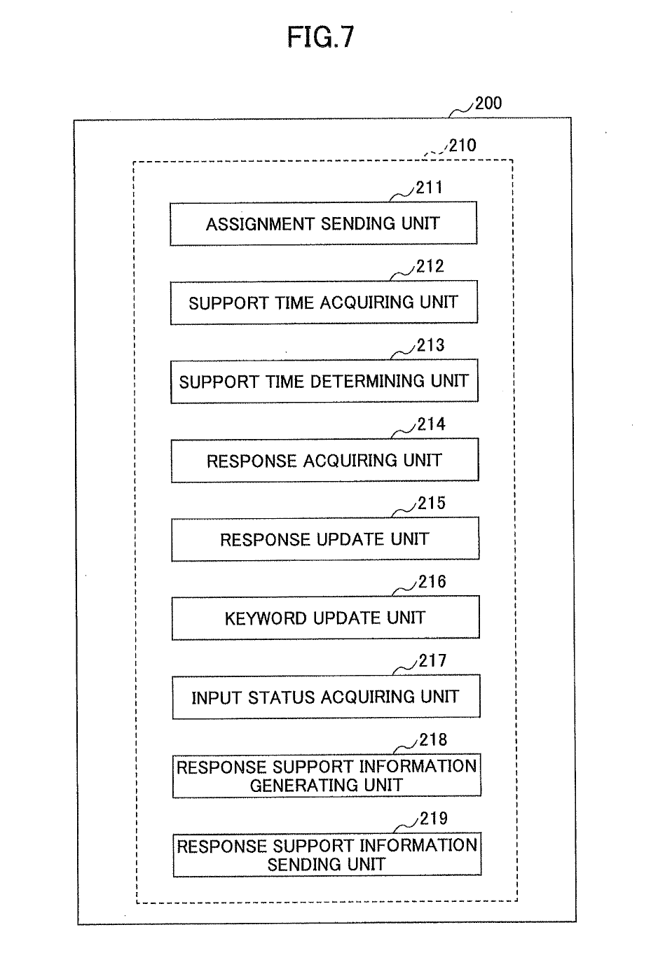

FIG. 7 illustrates an example of a functional configuration of the teacher terminal 200. In the present embodiment, the response support program 210 realizes the functions of the following units of the teacher terminal 200.

The teacher terminal 200 according to the present embodiment includes an assignment sending unit 211, a support time acquiring unit 212, a support time determining unit 213, a response acquiring unit 214, a response update unit 215, a keyword update unit 216, and an input status acquiring unit 217. The teacher terminal 200 further includes a response support information generating unit 218 and a response support information sending unit 219.

The assignment sending unit 211 according to the present embodiment refers to the assignment database 230 and displays an assignment selection screen on the teacher terminal 200, and sends an assignment corresponding to the selected assignment number to the student terminal 300. The support time acquiring unit 212 acquires information of the support display time corresponding to the assignment in the assignment database 230.

The support time determining unit 213 determines whether the support display time has elapsed from when input of an opinion has started. The response acquiring unit 214 acquires the response input at the student terminal 300. The response acquiring unit 214 according to the present embodiment acquires a response as “not input” if a response is not input at the student terminal 300.

The response update unit 215 updates the response database 240 according to the response acquired by the response acquiring unit 214. When the response acquired by the response acquiring unit 214 is “not input”, the response update unit 215 according to the present embodiment updates the response database 240 with “not input” indicated at the corresponding item.

The keyword update unit 216 updates the keyword database 250 using the opinion text included in the response acquired by the response acquiring unit 214. Details of the keyword update unit 216 are described below. The input status acquiring unit 217 refers to the response database 240 and acquires the input status of a response in the student terminal 300. Furthermore, the input status acquiring unit 217 determines the input status from the acquired input status. Specifically, when a response is not input into the response database 240, the input status acquiring unit 217 acquires that “a response is not input” as the input status. Furthermore, the input status acquiring unit 217 determines whether text data is input as an opinion and whether pro or con has been selected, in the response database 240.

The response support information generating unit 218 selects a keyword from the keyword database 250 according to the input status acquired by the input status acquiring unit 217, and sets the selected keyword or group of keywords as response support information. The response support information sending unit 219 sends response support information generated by the response support information generating unit 218 to the student terminal 300. The response update unit 215 updates the response database 240.

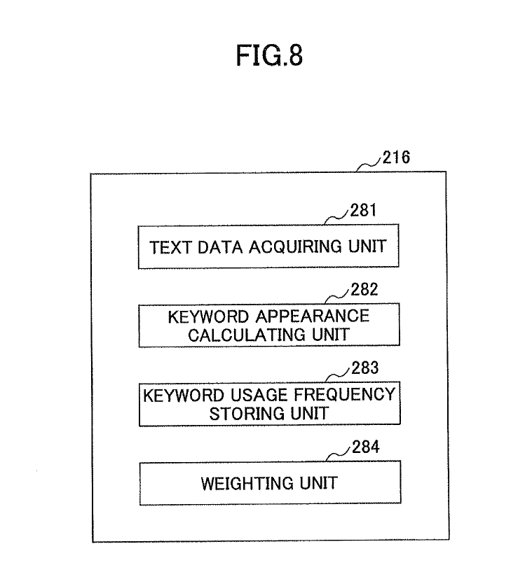

Next, with reference to FIG. 8, details of the keyword update unit 216 according to the present embodiment are described. FIG. 8 illustrates details of the keyword update unit 216. The keyword update unit 216 according to the present embodiment uses an opinion text included in a response acquired from the student terminal 300 to update the keyword database 250.

The keyword update unit 216 includes a text data acquiring unit 281, a keyword appearance calculating unit 282, a keyword usage frequency storing unit 283, and a weighting unit 284.

The text data acquiring unit 281 acquires text data included in the response acquired from the student terminal 300. The keyword appearance calculating unit 282 calculates the number of times the keyword selected from the keyword database 250 appears in the acquired text data.

The keyword usage frequency storing unit 283 stores the number calculated by the keyword appearance calculating unit 282 as the usage frequency of the corresponding keyword in the keyword database 250. The weighting unit 284 applies a priority level to the keyword stored in the keyword database 250 based on a weight coefficient set in advance.

Next, a description is given of the student terminal 300 according to the present embodiment.

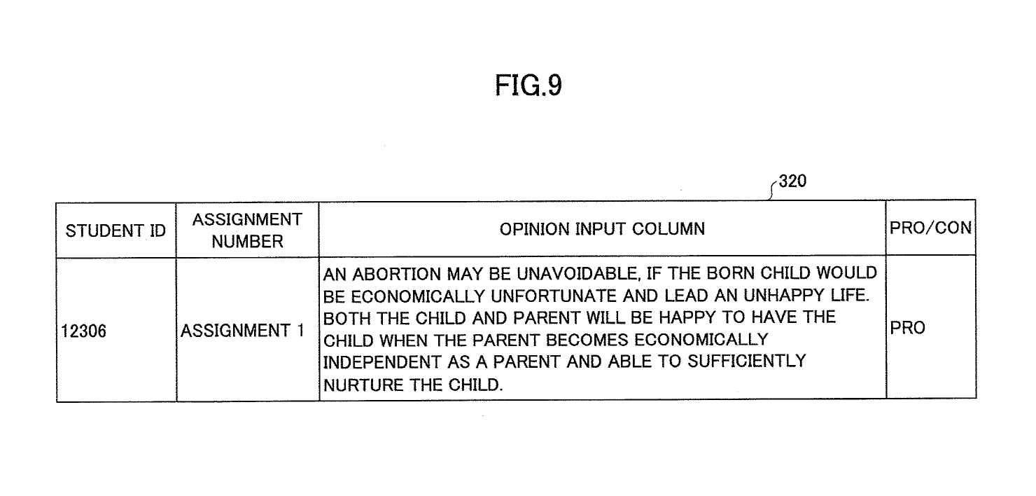

FIG. 9 illustrates an example of the response work table 320 stored in the student terminal 300. The response work table 320 according to the present embodiment stores responses made at the student terminal 300. The response work table 320 according to the present embodiment stores, in association with each other, the student ID of student using the student terminal 300, the assignment number, the opinion text, and pro or con.

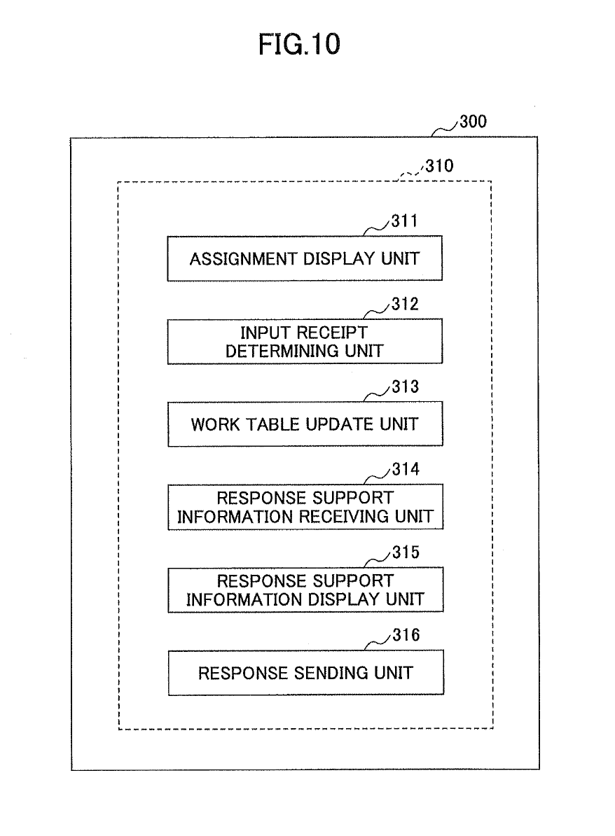

FIG. 10 illustrates a functional configuration of the student terminal 300. In the present embodiment, the response-use program 310 causes the student terminal 300 to realize the following functions.

The student terminal 300 includes an assignment display unit 311, an input receipt determining unit 312, a work table update unit 313, a response support information receiving unit 314, a response support information display unit 315, and a response sending unit 316.

When an assignment is received from the teacher terminal 200, the assignment display unit 311 according to the present embodiment generates an assignment display screen, and displays the assignment display screen. The input receipt determining unit 312 determines whether input of an opinion text or a selection of pro or con has been received at the student terminal 300. The work table update unit 313 updates the response work table 320 according to the received response. The response support information receiving unit 314 receives response support information sent from the teacher terminal 200. The response support information display unit 315 displays the received response support information on the screen. The response sending unit 316 sends the response to the teacher terminal 200.

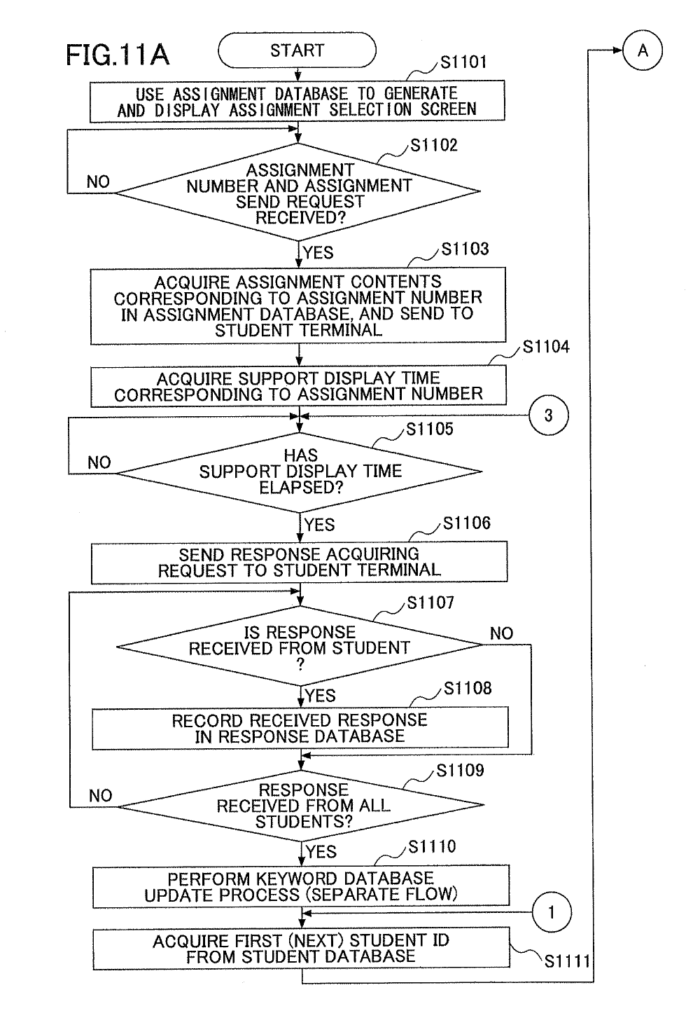

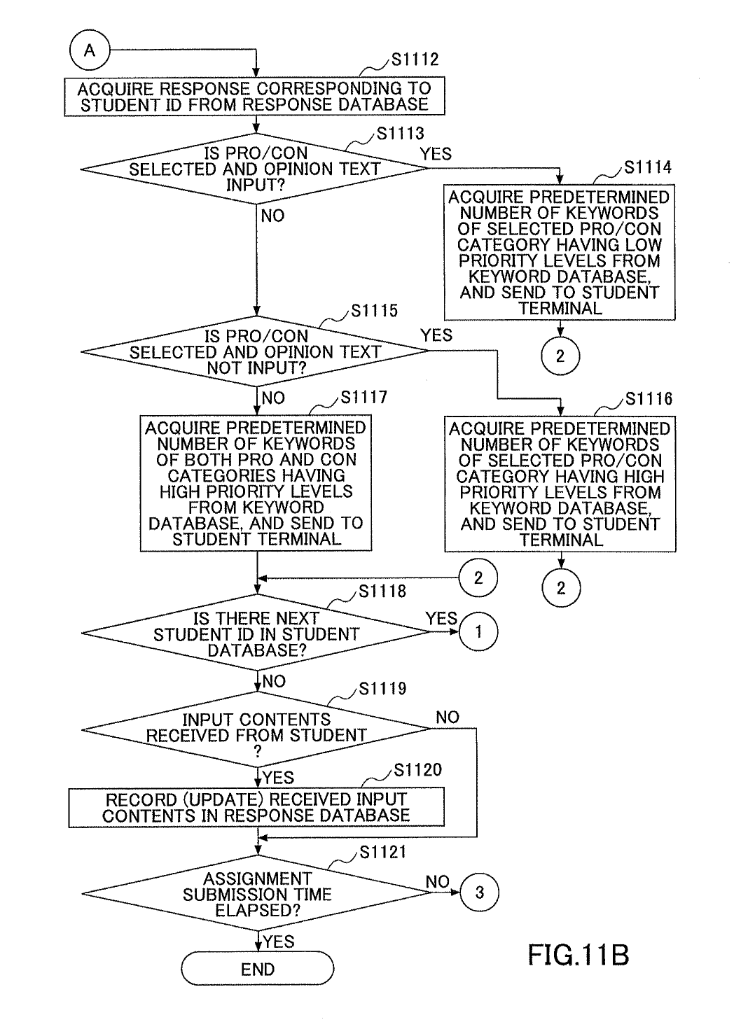

In the following, a description is given of operations of the response support system 100 according to the present embodiment. First, operations of the teacher terminal 200 according to the present embodiment are described. FIGS. 11A and 11B are a flowchart for describing operations of the teacher terminal 200.

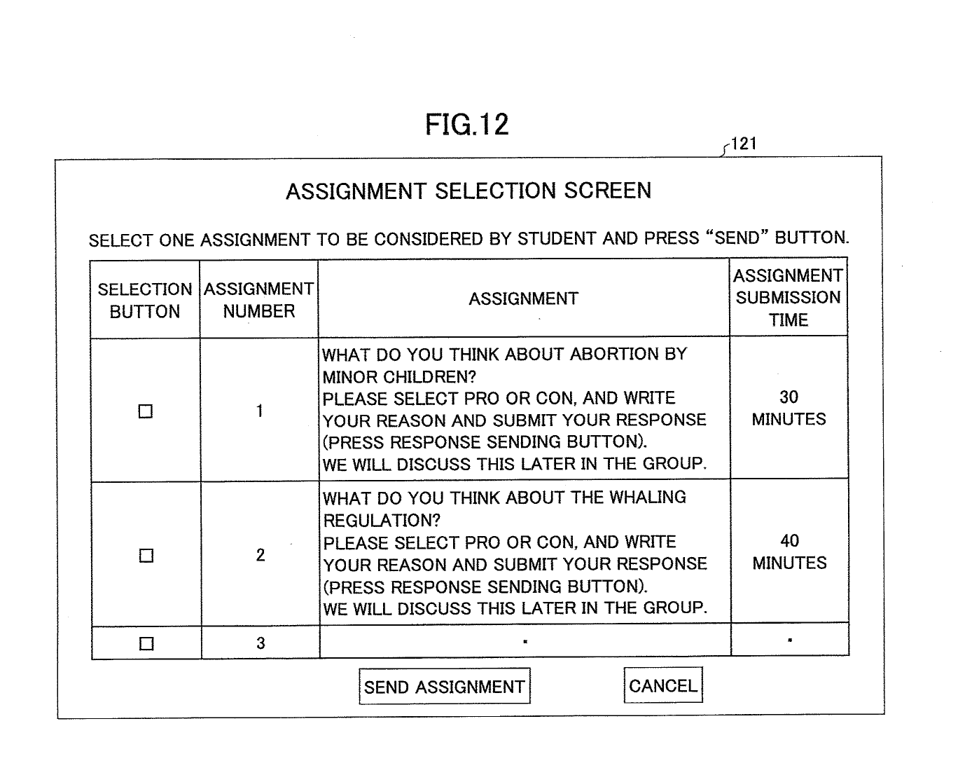

In the teacher terminal 200 according to the present embodiment, the assignment sending unit 211 refers to the assignment database 230 and displays an assignment selection screen on the teacher terminal 200 (step S1101). FIG. 12 illustrates an example of an assignment selection screen displayed on the teacher terminal 200. In an assignment selection screen 121, assignment numbers, assignments, and assignment submission times stored in the assignment database 230 are displayed, and prompts the teacher to select an assignment to be sent to the student terminal 300.

Next, the assignment sending unit 211 determines whether the teacher has selected an assignment in the assignment selection screen 121 (step S1102). When it is determined that an assignment has been selected in step S1102, the assignment sending unit 211 acquires an assignment corresponding to the assignment number selected in the assignment database 230, and sends the assignment to the student terminal 300 (step S1103). An assignment according to the present embodiment is the text of an assignment stored as text data. The teacher terminal 200 according to the present embodiment sends the same assignment to all student terminals 300. All student terminals 300 may mean, for example, all student terminals 300 logged into the response support system 100 by a log-in process. Alternatively, all student terminals 300 may mean student terminals 300 having IP addresses corresponding to student IDs stored in the student database 220.

Next, the teacher terminal 200 acquires, from the assignment database 230 by the support time acquiring unit 212, the support display time corresponding to the assignment number of the assignment sent to the student terminals 300 (step S1104). When there are plural support display times set in the assignment database 230, the support display times are acquired in ascending order of time length. For example, for assignment number 1 in the assignment database 230 illustrated in FIG. 4, three support display times are set. Therefore, the support time acquiring unit 212 acquires the support display time 1 which is shortest among the support display times in the assignment database 230.

Next, in the teacher terminal 200, the support time determining unit 213 determines whether the support display time acquired at step S1104 has elapsed (step S1105). When the support display time has elapsed in step S1105, the response acquiring unit 214 sends a response acquiring request to the student terminal 300 (step S1106). Next, the response acquiring unit 214 determines whether a response has been received from the student terminal 300 (step S1107).

When a response has been received in step S1107, the response update unit 215 updates the response database 240 according to the received response (step S1108). When a response has not been received in step S1107, the process proceeds to step S1109.

Next, the response acquiring unit 214 determines whether a response has been received from all student terminals 300 (step S1109). When a response has been received from all student terminals 300 at step S1109, the teacher terminal 200 updates the keyword database 250 by the keyword update unit 216 (step S1110). When a response has not been received from all student terminals 300 at step S1109, the process returns to step S1107.

In the present embodiment, by updating the keyword database 250 at this timing, the keyword database 250 is updated by using the keyword that is used until the support display time elapses in all student terminals 300. Details of updating the keyword database 250 are described below.

Next, in the teacher terminal 200, the input status acquiring unit 217 refers to the student database 220 and acquires the next student ID (step S1111). Next, the input status acquiring unit 217 refers to the response database 240 and acquires the input status corresponding to the student ID acquired at step S1111 (step S1112). The input status is, for example, information indicating whether a response has been input.

Next, the input status acquiring unit 217 determines the input status of response based on the acquired response. Specifically, the input status acquiring unit 217 determines whether a selection of pro or con and an opinion are input into the response (step S1113). In step S1113, when a selection of pro or con and an opinion are input, the response support information generating unit 218 selects a predetermined number of keywords having low priority levels from the keyword database 250, and uses the group of these keywords as response support information. Then, the teacher terminal 200 sends the response support information selected by the response support information sending unit 219 to the student terminal 300 (step S1114), and the process proceeds to step S118.

In the present embodiment, the response support information used for providing response support to the student is a keyword (or keywords); however, the present invention is not so limited. The response support information may be any kind of information for supporting a student to respond. For example, sentences and images created with the use of a keyword selected from the keyword database 250 may be used.

In step S1113, when a selection of pro or con and an opinion are not input, the input status acquiring unit 217 determines whether a selection of pro or con is input but an opinion is not input into the acquired response (step S1115).

When the condition of step S1115 is satisfied, the response support information generating unit 218 selects, from the keyword database 250, a predetermined number of keywords having the same pro/con category as that selected in the response and having high priority levels, and sets the selected keywords as the response support information. The teacher terminal 200 sends the response support information generated by the response support information sending unit 219 to the student terminal 300 (step S1116), and the process proceeds to step S1118.

When the condition of step S1115 is not satisfied, it means that neither a selection of pro or con nor an opinion are input. In this case, the response support information generating unit 218 selects a predetermined number of keywords having high priority levels from both the pro category and the con category from the keyword database 250, and sets these keywords as response support information. The teacher terminal 200 sends the response support information generated by the response support information sending unit 219 to the student terminal 300 (step S1117).

Next, the response acquiring unit 214 determines whether there is a next student ID in the student database 220 (step S1118). When there is a next student ID in step S1118, the teacher terminal 200 returns to step S1111.

In step S1118, when there is no student ID, the response acquiring unit 214 determines whether a response has been acquired from the student terminal 300 (step S1119). The response acquired here is a response after the response support information is sent, i.e., a response after response support is provided.

In step S1119, when a response after response support is provided, the response update unit 215 updates the response database 240 (step S1120). Next, the teacher terminal 200 refers to the assignment database 230 and determines whether the assignment submission time has elapsed (step S1121). In step S1121, when the assignment submission time has elapsed, the teacher terminal 200 ends the process. In step S1121, when the assignment submission time has not elapsed, the teacher terminal 200 returns to step S1105.

The teacher terminal 200 returns to step S1105, and when the support display time that is set next elapses, according to the process of step S1106 and onward, the response support information is sent to the student terminal 300 according to the input status of a response that is input again from the student terminal 300.

As described above, the teacher terminal 200 according to the present embodiment generates and sends response support information to be sent to the student terminal 300 according to the input status of the student when the support display time has elapsed. Therefore, input support is provided according to the level of the student. Furthermore, in the present embodiment, plural support display times are set, and therefore input support for a response is provided in a stepwise manner according to the level of each student.

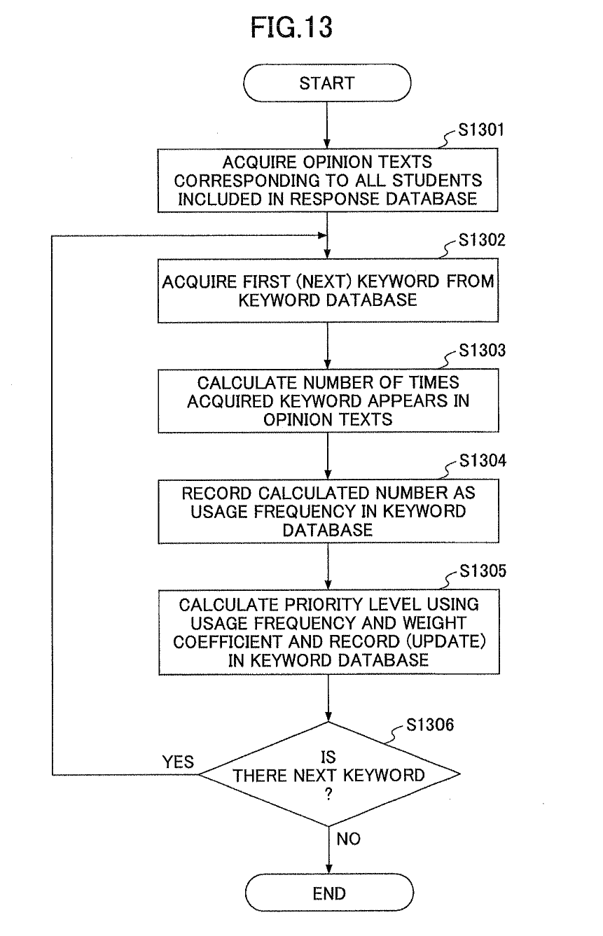

Next, with reference to FIG. 13, a description is given of updating the keyword database 250 according to the present embodiment. FIG. 13 is a flowchart for describing a process performed by the keyword update unit 216.

The keyword update unit 216 according to the present embodiment acquires, by the text data acquiring unit 281, opinion texts corresponding to all student IDs included in the response database 240 (step S1301). Next, the keyword update unit 216 acquires the first keyword from the keyword database 250 (step S1302).

Next, the keyword update unit 216 calculates, by the keyword appearance calculating unit 282, the number of times the keyword acquired at step S1302 appears in all of the text data acquired at step S1301 (step S1303). That is to say, the keyword appearance calculating unit 282 calculates the number of times the keyword acquired at step S1302 appears in all of the opinion texts included in the response database 240.

Next, the keyword update unit 216 stores, in the keyword database 250 by the keyword usage frequency storing unit 283, the frequency calculated at step S1303 as the usage frequency of the keyword acquired at step S1301 (step S1304).

Next, the keyword update unit 216 calculates, by the weighting unit 284, the priority level of the keyword acquired at step S1301 using the usage frequency of the keyword and a weight coefficient set in advance, and stores the priority in the keyword database 250 (step S1305).

Next, the keyword update unit 216 determines whether there is a next keyword in the keyword database 250 (step S1306). When there is a next keyword in step S1306, the keyword update unit 216 returns to step S1302. When there is no next keyword in step S1306, the keyword update unit 216 ends the process.

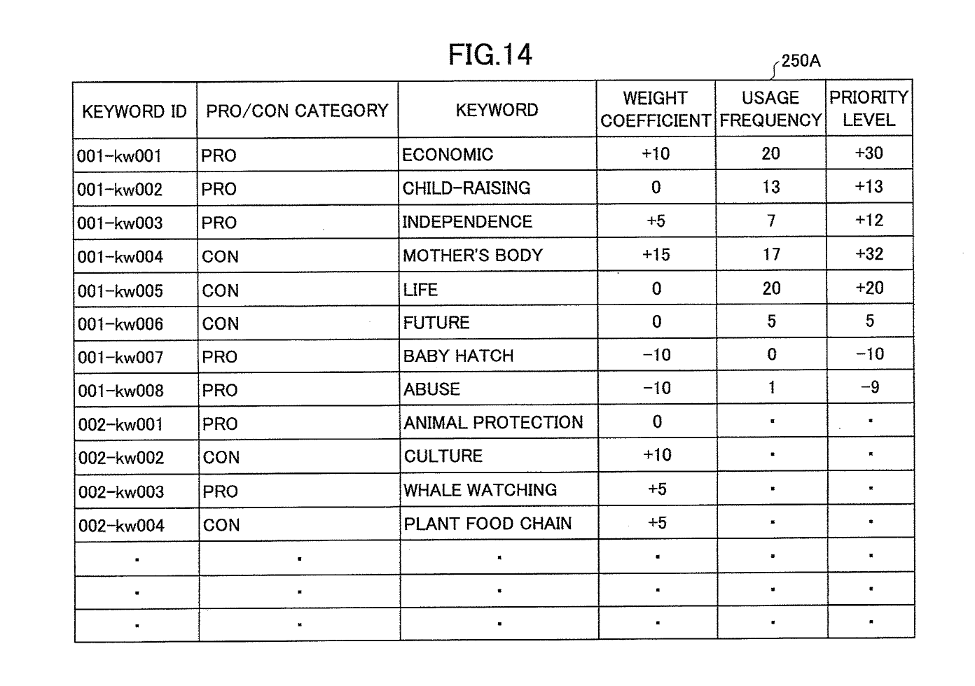

In the following, with reference to FIG. 14, a detailed description is given of the operation of updating the keyword database 250 according to the present embodiment.

FIG. 14 illustrates an example of a keyword database after being updated. A keyword database 250A illustrated in FIG. 14 is obtained by updating the keyword database 250 illustrated in FIG. 5, and the usage frequency and priority level are stored for each keyword.

For example, the keyword update unit 216 according to the present embodiment acquires “economic”, which is a keyword corresponding to the keyword ID 001-kw001. The keyword update unit 216 calculates the number of times the keyword “economic” appears in all opinion texts stored in the response database 240. In the example of FIG. 14, the usage frequency of the keyword “economic” is 20 times. Furthermore, the priority level of the keyword “economic” is +30, obtained by adding the weight coefficient +10 and the usage frequency of 20 times.

In the present embodiment, the keyword database 250 is updated after the support display time elapses; however, the present invention is not so limited. The updating of the keyword database 250 is not dependent on the support display time, and may be performed at an arbitrary timing. However, in consideration of calculating the usage frequency, the updating is preferably performed after a predetermined time period elapses after an opinion text starts to be input.

Furthermore, when updating the keyword database 250, the weight coefficient may be updated as well. Specifically, for example, it is possible to reduce the weight coefficient of a keyword having a high usage frequency the last time the keyword database 250 was updated.

By the above method, a keyword, which had a high priority level at the time of the previous update, is made to have a lower priority level. Therefore, it is possible to prevent the same keyword from being selected all the time as a keyword having a high priority level, and the student is prompted to use a wider variety of expressions. As a result, subsequent discussions are made with a wider range of issues.

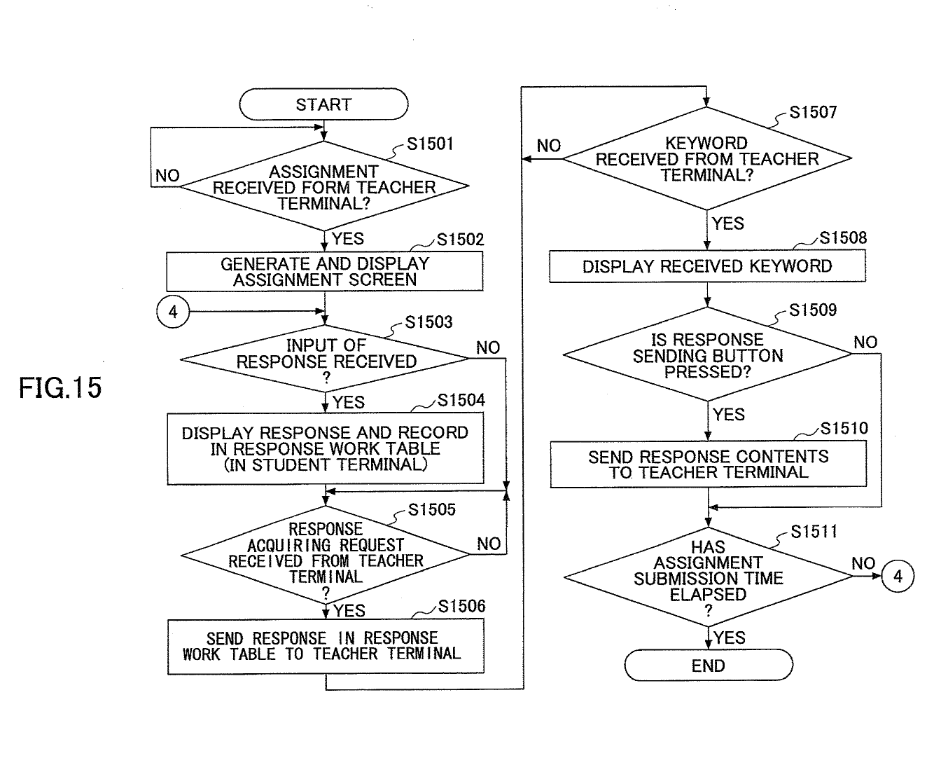

Next, a description is given of operations of the student terminal 300 according to the present embodiment. FIG. 15 is a flowchart for describing operations of the student terminal 300.

In the student terminal 300 according to the present embodiment, the assignment display unit 311 determines whether an assignment has been received from the teacher terminal 200 (step S1501). When an assignment has been received at step S1501, the assignment display unit 311 generates an assignment screen, and displays the assignment screen on a display operation device of the student terminal 300 (step S1502).

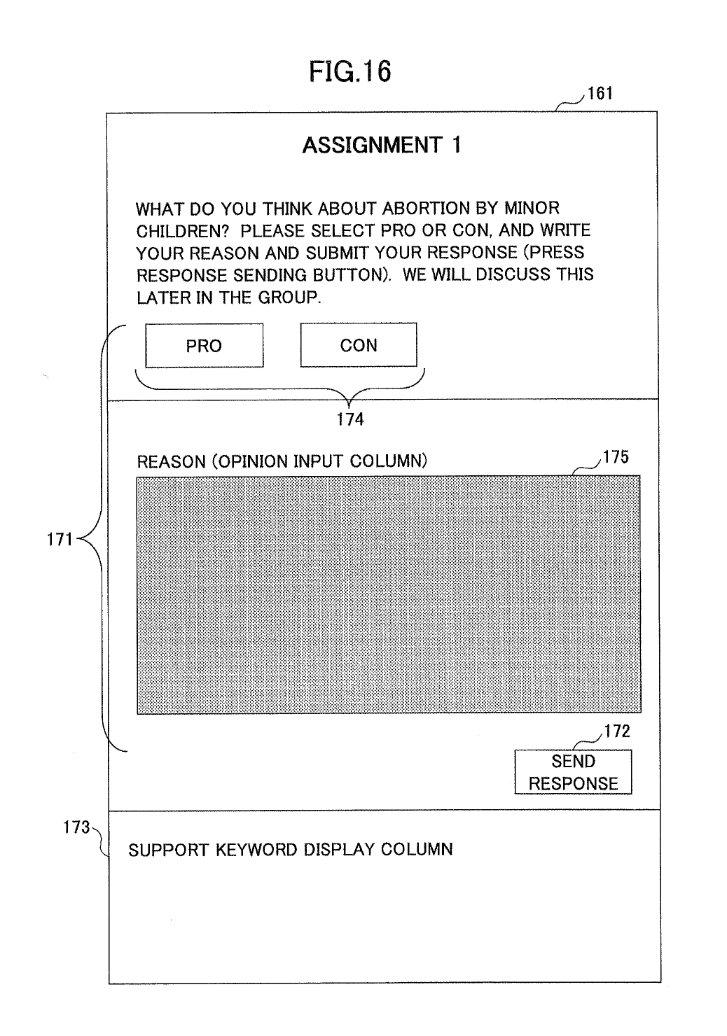

FIG. 16 illustrates an example of an initial assignment screen. When an assignment is received from the teacher terminal 200, the student terminal 300 displays an assignment screen 161 illustrated in FIG. 16. In the assignment screen 161, an assignment number and an assignment, a response column 171, a response sending button 172, and a response support information display column 173 are displayed.

The assignment according to the present invention includes a question requesting an opinion from the student. The response column 171 includes a pro con selection column 174 and an opinion input column 175. At the pro con selection column 174, a selection is to be made as to pro or con with regard to the question. At the opinion input column 175, the reason for pro or con is input. The response support information display column 173 is a column for displaying the response support information that is sent from the teacher terminal 200.

The assignment screen 161 is an initial screen, and a selection of pro and con and an opinion regarding the assignment is not input, and the response support information is not displayed.

In the present embodiment, the assignment is displayed in each of the student terminals 300; however, the present invention is not so limited. For example, the assignment may be displayed on a display device that may be viewed by all students.

Next, the student terminal 300 determines, by the input receipt determining unit 312, whether input of a response has been received (step S1503). When input of a response is received at step S1503, the input response is displayed, and the work table update unit 313 updates the response work table 320 (step S1504). When input of a response is not received at step S1503, the process proceeds to step S1505 described below.

Next, the response sending unit 316 determines whether a response acquiring request has been received (step S1505). When a response acquiring request has been received at step S1505, the response sending unit 316 sends the response stored in the response work table 320 to the teacher terminal 200 (step S1506). When a response acquiring request has not been received at step S1505, the response sending unit 316 waits until a response acquiring request is received.

Next, in the student terminal 300, the response support information receiving unit 314 determines whether response support information has been received from the teacher terminal 200 (step S1507). When response support information has been received at step S1507, the response support information display unit 315 displays the received response support information in the response support information display column 173 (step S1508).

Next, the response sending unit 316 determines whether the response sending button 172 has been operated (step S1509). When the response sending button 172 has been operated in step S1509, the response sending unit 316 sends the contents of the response work table 320 to the teacher terminal 200 (step S1510). When the response sending button 172 has not been operated in step S1509, the process proceeds to step S1511 described below.

Next, the student terminal 300 determines whether the assignment submission time has elapsed (step S1511). When the assignment submission time has elapsed in step S1511, the student terminal 300 ends the process. When the assignment submission time has not elapsed in step S1511, the student terminal 300 returns to step S1503.

In the following, a description is given of a case where response support information is displayed on the student terminal 300 according to the present embodiment.

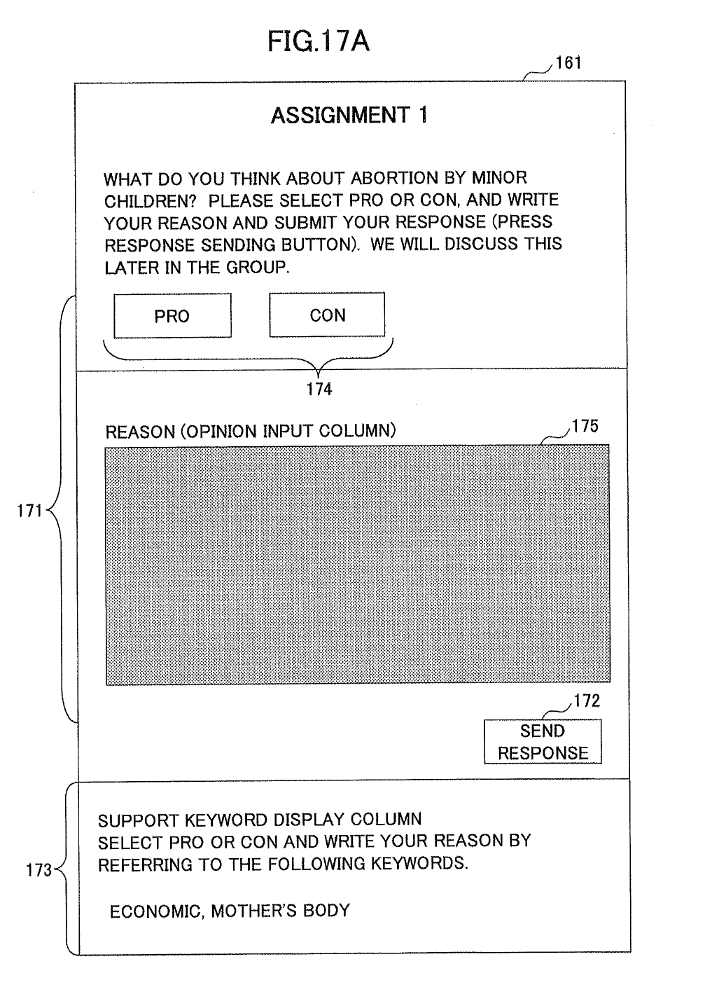

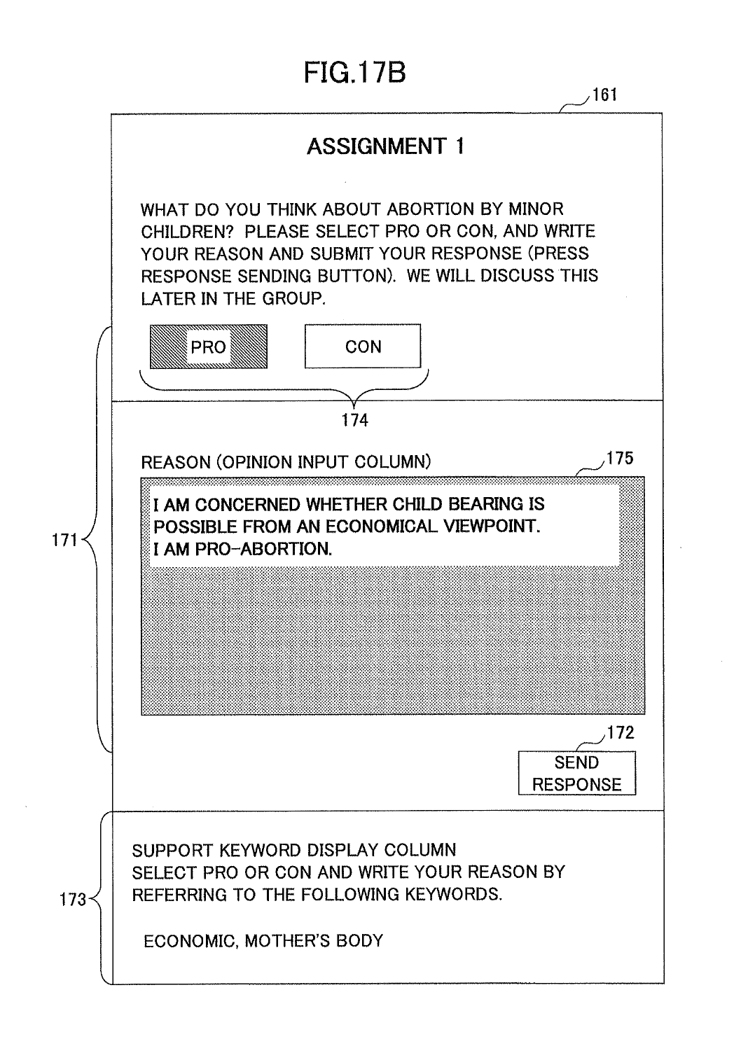

FIGS. 17A and 17B illustrate a first example where response support information is displayed on the student terminal 300. FIG. 17A illustrates the assignment screen 161 immediately after the response support information is displayed, and FIG. 17B illustrates the assignment screen 161 immediately after the assignment submission time has elapsed.

FIGS. 17A and 17B illustrate a case where neither a selection of pro or con or an opinion text are input after the support display time has elapsed.

In this case, the response support information generating unit 218 of the teacher terminal 200 selects keywords having a high priority level from both the pro category and the con category from the keyword database 250A, and sends the selected keywords as response support information to the student terminal 300.

In FIG. 17A, for example, a keyword “economic” having the highest priority level in the pro category in the keyword database 250A and a keyword “mother's body” having the highest priority level in the con category in the keyword database 250A are displayed in the response support information display column 173. In the example of FIGS. 17A and 17B, one keyword is displayed for each pro con category; however, there may be plural keywords displayed for each pro con category.

In FIG. 17B, after the response support information is displayed, pro or con is selected at the response acquiring unit 214, and an opinion including the keyword “economic” of the pro category is input.

As described above, for a student who has not selected pro or con even when the support display time has elapsed, keywords are selected from both the pro category and the con category and are displayed as response support information. Therefore, such a student is prompted to select pro or con and to input an opinion text.

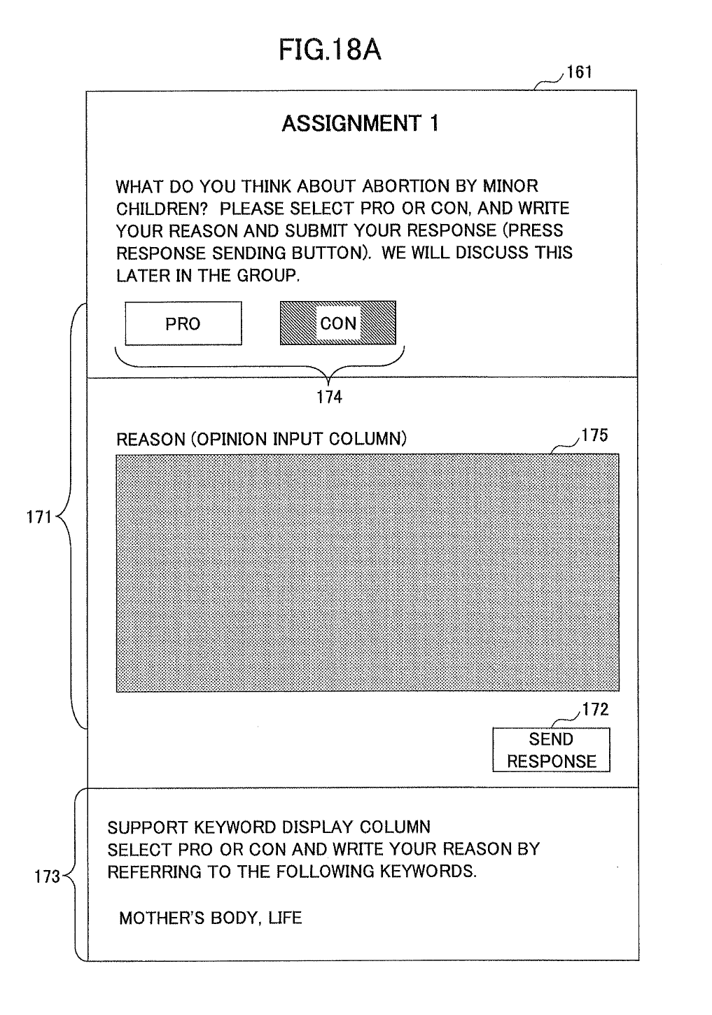

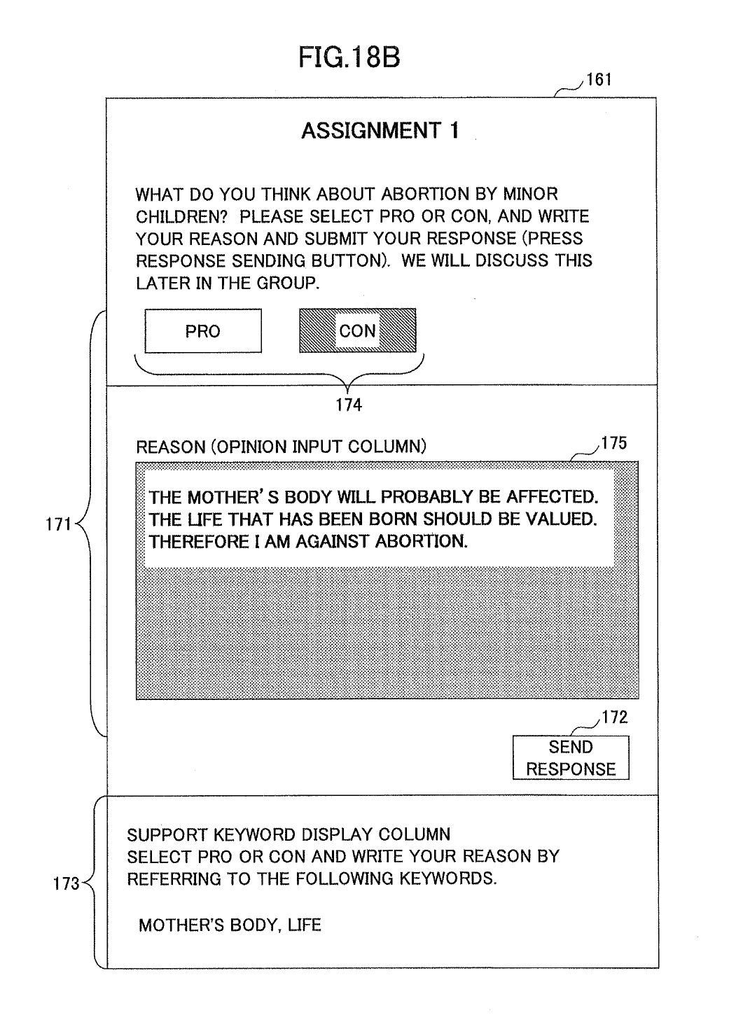

FIGS. 18A and 18B illustrate a second example where response support information is displayed on the student terminal 300. FIG. 18A illustrates the assignment screen 161 immediately after the response support information is displayed, and FIG. 18B illustrates the assignment screen 161 immediately after the assignment submission time has elapsed.

FIGS. 18A and 18B illustrate a case where a selection of pro or con has been input but an opinion text is not input after the support display time has elapsed.

In this case, the response support information generating unit 218 of the teacher terminal 200 selects keywords having a high priority level from the pro/con category that has been selected from the keyword database 250A, and sends the selected keywords as response support information to the student terminal 300.

In FIG. 18A, “con” is selected. Therefore, in FIG. 18A, for example, the keywords “mother's body” and “life” having the highest priority levels in the “con” category in the keyword database 250A illustrated in FIG. 14 are displayed in the response support information display column.

In FIG. 18B, an opinion text including the keywords “mother's body” and “life” is input after the response support information is displayed.

As described above, for a student who has not input an opinion text even when the support display time has elapsed, keywords are selected from the pro/con category selected by the student and are displayed as response support information. Therefore, such a student is prompted to input an opinion text.

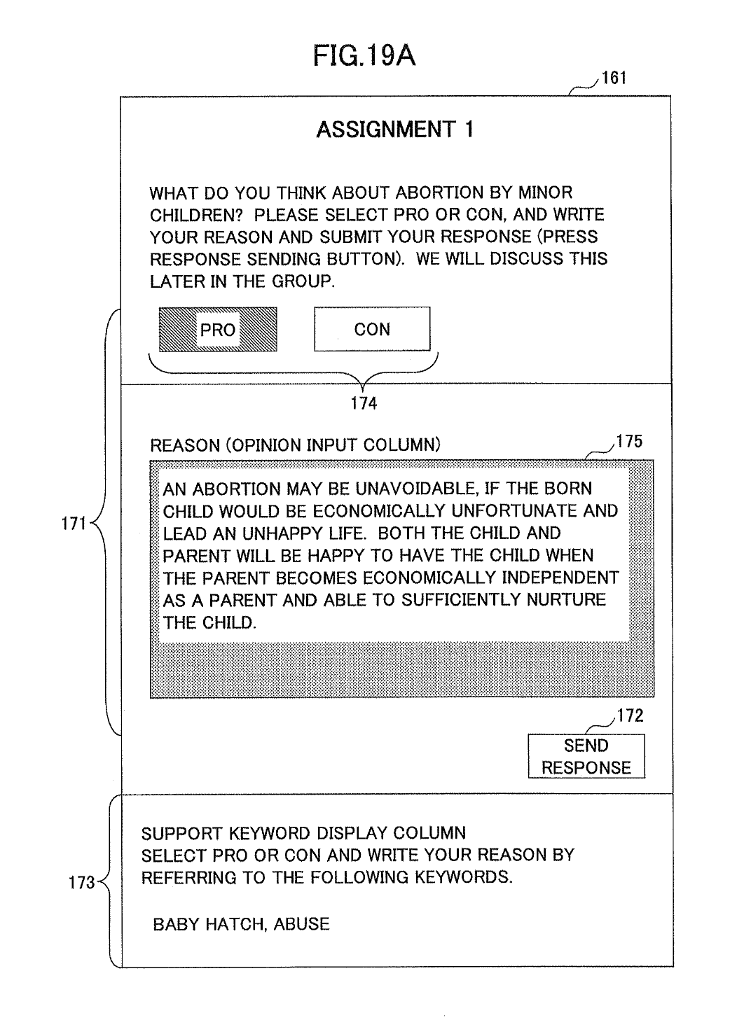

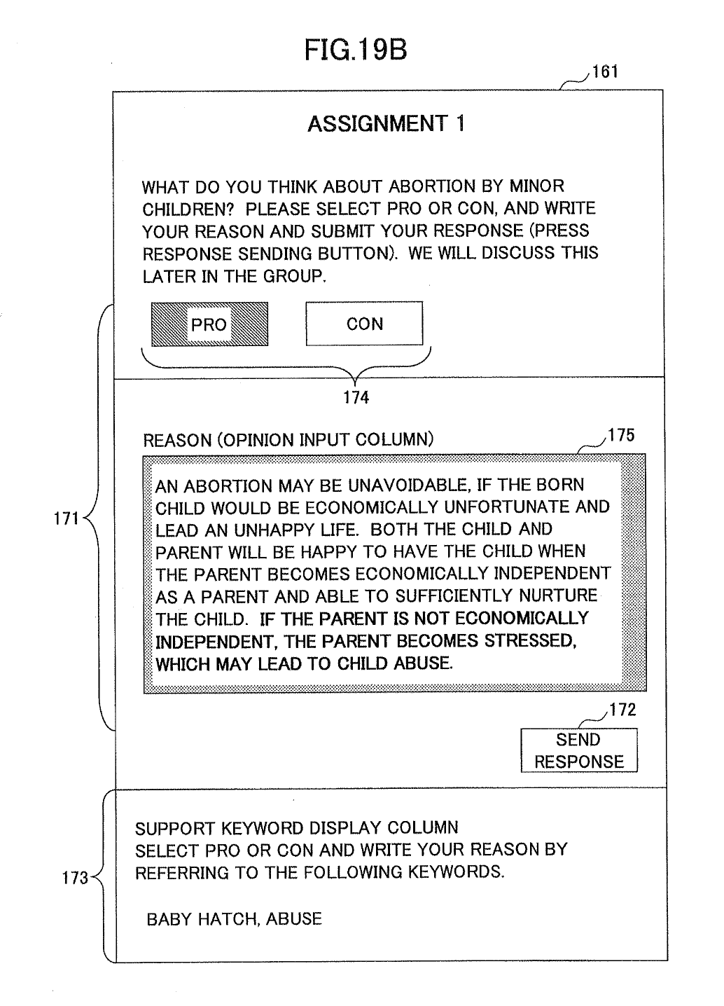

FIGS. 19A and 19B illustrate a third example where response support information is displayed on the student terminal 300. FIG. 19A illustrates the assignment screen 161 immediately after the response support information is displayed, and FIG. 19B illustrates the assignment screen 161 immediately after the assignment submission time has elapsed.

FIGS. 19A and 19B illustrate a case where both a selection of pro or con and an opinion text are input.

In this case, the response support information generating unit 218 of the teacher terminal 200 selects keywords having a low priority level from the pro/con category that has been selected from the keyword database 250A, and sends the selected keywords as response support information to the student terminal 300.

In FIG. 19A, “pro” is selected. Therefore, in FIG. 19A, for example, the keywords “baby hatch” and “abuse” having the lowest priority levels in the “pro” category in the keyword database 250A illustrated in FIG. 14 are displayed in the response support information display column.

In FIG. 19B, an opinion text is input after the response support information including the keywords “baby hatch” and “abuse” is displayed. In the present embodiment, as illustrated in FIG. 19B, an opinion text input after the response support information is displayed may be displayed in bold letters. That is to say, in the present embodiment, the opinion text input before the response support information is displayed and the opinion text input after the response support information is displayed may be displayed in a distinguishable manner.

As described above, for a student who has finished inputting a selection of pro or con and an opinion text when the support display time has elapsed, keywords having a low priority level in the pro/con category that has been selected by the student are displayed as the response support information, to prompt a wider range of expressions to be used.

In the teacher terminal 200 according to the present embodiment, a response is received from the student terminal 300 after the assignment submission time has elapsed, and the response database 240 is updated.

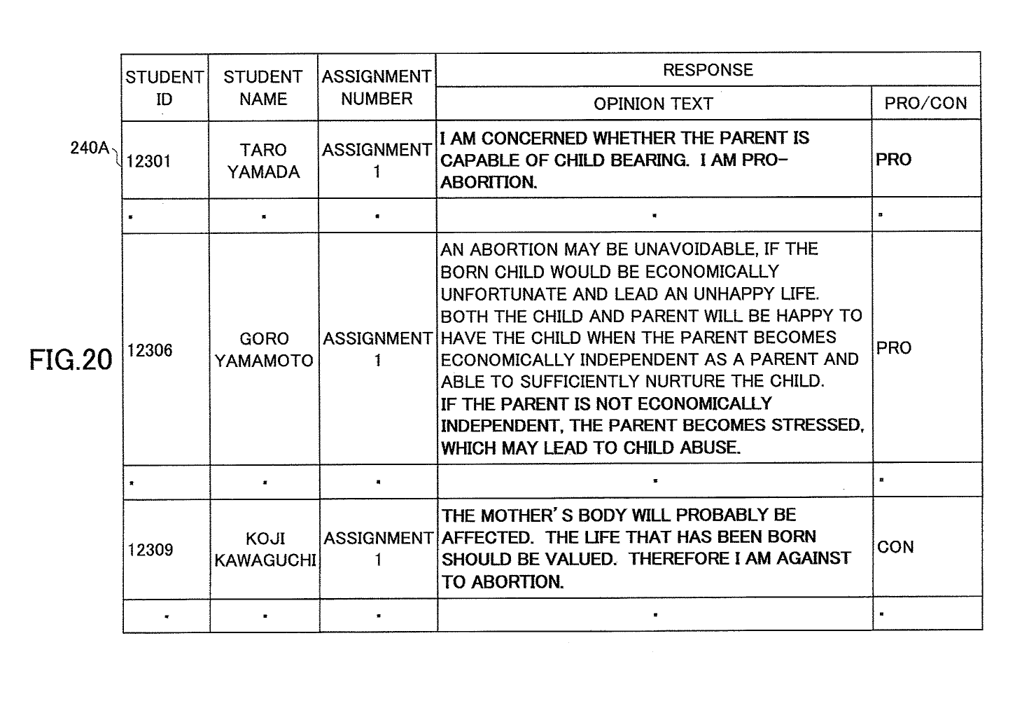

FIG. 20 illustrates an example of the response database 240A after the assignment submission time has elapsed. Responses are stored in the response database 240A after the assignment submission time has elapsed according to the present embodiment in a manner that it is possible to distinguish opinion texts and selections of pro or con that are input after the response support information is displayed and opinion texts and selections of pro or con that are input before the response support information is displayed.

In the example of FIG. 20, for example, the student having a student ID of 12301 has input an opinion text and a selection of pro or con of the response after the response support information is displayed. The student having a student ID of 12306 has added an opinion text of the response after the response support information is displayed. That is to say, this student has input a selection of pro or con and an opinion text before the response support information is displayed.

Therefore, in the present embodiment, by displaying the response database 240A at the teacher terminal 200, the teacher is able to recognize the extent to which each student has responded (or not responded) to the assignment without response support.

As described above, according to the present embodiment, the response support information is displayed on the student terminal 300 according to the input status of the student's response. Therefore, it is possible to help a student who is unable to input his own opinion. Furthermore, a student who has input his opinion is prompted to think in a wider, deeper range. As a result, subsequent discussions are made with a wider range of issues.

According to an aspect of the embodiments, input support is performed in accordance with the level of each respondent.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A response support server for providing response support to a response terminal for an assignment that has been presented, the response support server comprising:
an input status acquisition unit configured to acquire an input status in a response column for the assignment;
a response support information generation unit configured to generate response support information to be displayed on the response terminal, based on the input status and an elapsed time after the assignment is presented; and
a send unit configured to send the response support information to the response terminal.

2. The response support server according to claim 1, wherein
the response support information generation unit is configured to
refer to a keyword database storing a keyword to which a priority level is given,
generate the response support information by selecting a predetermined number of the keywords having a high priority level, when the input status indicates no input, and
generate the response support information by selecting a predetermined number of the keywords having a low priority level, when the input status indicates already input.

3. The response support server according to claim 2, wherein
the response column includes a selection part where a selection of pro or con is made for the assignment, and an opinion input part in which an opinion text for the assignment is input, and
the input status acquisition unit is configured to acquire the input status including information indicating whether the selection has been made in the selection part and whether the opinion text has been input into the opinion input part.

4. The response support server according to claim 3, wherein
the keyword stored in the keyword database is classified into a pro category and a con category,
the response support information generation unit is configured to
generate the response support information by selecting a predetermined number of the keywords having a high priority level from both the pro category and the con category, when the selection is not made in the selection part,
generate the response support information by selecting a predetermined number of the keywords having a high priority level from one of the pro category or the con category selected in the selection part, when the selection is made in the selection part but the opinion text is not input into the opinion input part, and
generate the response support information by selecting a predetermined number of the keywords having a low priority level from one of the pro category or the con category selected in the selection part, when the selection is made in the selection part and the opinion text is input into the opinion input part.

5. The response support server according to claim 2, further comprising:
a keyword update unit configured to update the priority level of the keyword in the keyword database based on a usage frequency of the keyword in a response database storing a response input to the response column.

6. The response support server according to claim 5, wherein
the keyword stored in the keyword database is weighted in advance, and
the keyword update unit is configured to update the priority level based on the usage frequency of the keyword and a weight coefficient of the keyword.

7. The response support server according to claim 1, wherein
the input status acquisition unit is configured to determine the input status in the response column in the response terminal, and
the response support information generation unit is configured to generate the response support information for each of a plurality of the response terminals in accordance with the input status of each of a plurality of the response terminals.

8. A response support system comprising:
a response terminal; and
a response support server configured to provide response support to the response terminal, wherein
the response support server includes
an input status acquisition unit configured to acquire an input status in a response column for an assignment that has been presented,
a response support information generation unit configured to generate response support information to be displayed on the response terminal, based on the input status and an elapsed time after the assignment is presented, and
a send unit configured to send the response support information to the response terminal.

9. A method performed by a computer for providing response support to a response terminal for an assignment that has been presented, the method comprising:
acquiring an input status in a response column for the assignment;
generating response support information to be displayed on the response terminal, based on the input status and an elapsed time after the assignment is presented; and
sending the response support information to the response terminal.

10. A non-transitory computer-readable recording medium storing a response support program that causes a computer to execute a process comprising:
acquiring an input status in a response column for an assignment that has been presented;
generating response support information to be displayed on a response terminal, based on the input status and an elapsed time after the assignment is presented; and
sending the response support information to the response terminal.
